(19) United States
(12) Patent Application Publication
(10) Pub. No.: US 2026/0136164 A1
(43) Pub. Date: May 14, 2026

(54) IN-VEHICLE NETWORK SYSTEM AND CONTROL METHOD FOR IN-VEHICLE NETWORK SYSTEM

(71) Applicant: DENSO CORPORATION, Kariya-city (JP)

(72) Inventors: Sho MATSUMOTO, Kariya-city (JP); Tomohisa KISHIGAMI, Kariya-city (JP)

(21) Appl. No.: 19/359,231

(22) Filed: Oct. 15, 2025

(30) Foreign Application Priority Data
Nov. 14, 2024 (JP) 2024-199237

(51) Int. Cl. H04W 4/48

(52) U.S. Cl. CPC H04W 4/48

(57) ABSTRACT

An in-vehicle network system is controlled by transmitting, to a second controller, a relay control message containing an instruction to turn on or off a relay circuit based, which is disposed on a power supply line to a first controller, on a vehicle state of a vehicle, transmitting, to the second controller, an activation network management message, which causes the second controller to transition from a low-power consumption mode to the normal operation mode and contains an instruction to selectively activate the first controller, in response to an activation trigger, and turning on or off the relay circuit based on the instruction contained in the activation NM message until the second controller receives the relay control message.

### CROSS REFERENCE TO RELATED APPLICATION

The present application claims the benefit of priority from Japanese Patent Application No. 2024-199237 filed on November 14, 2024. The entire disclosure of the above application is incorporated herein by reference.

### TECHNICAL FIELD

The present disclosure relates to an in-vehicle network system having multiple control devices that are connected to a communication bus and capable of mutually communicating with each other in a vehicle, and to a control method for the in-vehicle network system.

### BACKGROUND ART

An intermediate ECU is supplied with power from a power source and has a relay that can switch between supplying and cutting off power from the power source to a lower-level ECU. The intermediate ECU closes the relay to supply power from the power source to the lower-level ECU in response to a message received from a higher-level ECU.

### SUMMARY

An in-vehicle network system includes a first controller, a second controller, and a third controller. The second controller is positioned hierarchically higher than the first controller. The second controller includes at least one of (i) a first circuit and (ii) a first processor with a memory storing computer program code executable by the first processor, and the at least one of the first circuit and the first processor configured to cause the second controller to turn on or off a relay circuit that is disposed on a power supply line to the first controller. The third controller includes at least one of (i) a second circuit and (ii) a second processor with a memory storing computer program code executable by the second processor. The third controller may include a power supply control master and a NM control master. The power supply control master is configured to transmit a relay control message to the second controller based on a vehicle state of the vehicle. The relay control message contains an instruction to turn on or off the relay circuit. The NM control master may be configured to transmit an activation network management (NM) message to the second controller through the communication bus in response to an activation trigger that requires the second controller to operate in a normal operation mode. The activation NM message may cause the second controller in a low-power consumption mode to enter the normal operation mode and contain an instruction to selectively activate the first controller. The second controller may be configured to turn on or off the relay circuit based on the instruction contained in the activation NM message until the second controller receives the relay control message from the power supply control master.

### BRIEF DESCRIPTION OF DRAWINGS

FIG. 1 is a diagram showing an example of the configuration of an in-vehicle network system according to the first embodiment.

FIG. 2 is an explanatory diagram for describing an example of an NM message, PN request information, and PNC setting information.

FIG. 3 is a sequence diagram illustrating a case in which, relay control processing is executed in accordance with a relay control message after an intermediate ECU in a low-power consumption mode is activated by an activation NM message.

FIG. 4 is a sequence diagram showing an example of the flow of processing executed by the higher-level ECU, intermediate ECUs, and lower-level ECUs in response to an activation trigger in the first embodiment.

FIG. 5 is a diagram showing an example of a PNC setting table stored in a storage of the intermediate ECU.

FIG. 6 is a diagram showing an example of relay connection information stored in the storage of the intermediate ECU.

FIG. 7 is a flowchart showing an example of processing executed by the higher-level ECU, intermediate ECUs, and lower-level ECUs, respectively, in response to an activation trigger in the first embodiment.

FIG. 8 is a sequence diagram showing an example of the flow of processing executed by the higher-level ECU, intermediate ECUs, and lower-level ECUs in response to an activation trigger in the second embodiment.

FIG. 9 is a flowchart showing an example of processing executed by the higher-level ECU, intermediate ECUs, and lower-level ECUs, respectively, in response to an activation trigger in the second embodiment.

FIG. 10 is a diagram showing an example of the configuration of an in-vehicle network system according to a modification.

### DESCRIPTION OF EMBODIMENTS

To begin with, examples of relevant techniques will be described.

For example, there is an in-vehicle network system including a higher-level ECU, an intermediate ECU, and a lower-level ECU. In the in-vehicle network system, the intermediate ECU is supplied with power from a power source and has a relay that can switch between supplying and cutting off power from the power source to the lower-level ECU. The intermediate ECU closes the relay to supply power from the power source to the lower-level ECU in response to a message received from the higher-level ECU. In other words, the intermediate ECU keeps the lower-level ECU in a power cutoff state until the intermediate ECU receives a message from the higher-level ECU. The lower-level ECU transitions from the power cutoff state to a standby state in which the lower-level ECU waits for instructions, when power is supplied to the lower-level ECU.

In the system described above, the intermediate ECU in the standby state is configured to receive messages from the higher-level ECU. The intermediate ECU transitions from the standby state to an activated state in response to receiving a message from the higher-level ECU. Then, the intermediate ECU having entered the activated state closes the relay and starts supplying power to the lower-level ECU.

Here, for achieving further reduction in power consumption, an ECU configured to switch between supply and cutoff of power to the lower-level ECU may enter a low-power consumption mode such as a sleep state or power cutoff state, in which message reception is not possible, instead of a standby state in which message reception is possible.

However, when the ECU is in a low-power consumption mode, it is necessary to transition the ECU from the low-power consumption mode, in which message reception is not possible, to a normal operation mode, which corresponds to an activated state, in which message reception is possible, prior to receiving a message from the higher-level ECU. The ECU having entered the normal operation mode will start the process of turning on the relay in response to receiving a message from the higher-level ECU. Thus, a relatively long time is required before starting power supply to the lower-level ECU.

The present disclosure has been made in view of the above points, and provides an in-vehicle network system and a control method for the in-vehicle network system that are capable of shortening the time required to start power supply to a lower-level control device, even when the operation mode of a higher-level control device, which has a function of switching between the supply and cutoff of power to the lower-level control device using a relay, is in a low-power consumption mode.

To achieve the above object, an in-vehicle network system according to the present disclosure includes a first controller, a second controller that is positioned hierarchically higher than the first controller, a power supply control master, and a NM control master. The first controller and the second controller are connected to a communication bus to communicate with each other in a vehicle. The second controller includes a relay control unit configured to turn on or off a relay circuit that is disposed on a power supply line to the first controller. The power supply control master is configured to transmit a relay control message to the second controller based on a vehicle state of the vehicle. The relay control message contains an instruction to turn on or off the relay circuit. The NM control master is configured to transmit an activation network management (NM) message to the second controller through the communication bus in response to an activation trigger that requires the second controller to transition to a normal operation mode. The activation NM message causes the second controller to transition from a low-power consumption mode to the normal operation mode and contains an instruction to selectively activate the first controller. The second controller is configured to turn on or off the relay circuit based on the instruction contained in the activation NM message until the second controller receives the relay control message from the power supply control master.

Further, a control method in the present disclosure is for an in-vehicle network system including a first controller and a second controller positioned hierarchically higher than the first controller. The control method including transmitting, to the second controller, a relay control message containing an instruction to turn on or off a relay circuit, which is disposed on a power supply line to the first controller, based on a vehicle state, and transmitting, to the second controller, an activation network management (NM) message through a communication bus in response to an activation trigger that requires the second controller to transition to a normal operation mode. The activation NM message causes the second controller to transition from a low-power consumption mode to the normal operation mode and contains an instruction to selectively activate the first controller. The control method further includes turning on or off, with a relay control unit of the second controller, the relay circuit based on the instruction contained in the activation NM message until the second controller receives the relay control message.

According to the in-vehicle network system and the control method for the in-vehicle network system of the present disclosure, the NM control master transmits an activation NM message to the second controller in response to the activation trigger that requires the second controller to transition to the normal operation mode. The activation NM message causes the second controller to transition from the low-power consumption mode to the normal operation mode. The activation NM message transitions the operation mode of the second controller from the low-power consumption mode to the normal operation mode.

In addition, the activation NM message includes an instruction to selectively activate the first controller. Thus, the second controller can turn on or off the relay circuit based on the instruction contained in the NM message to selectively activate the first controller until the second controller receives the relay control message from the power supply master. As a result, processing to start supplying power to the lower-level control device can be performed even before the relay control message is provided to the higher-level control device, making it possible to shorten the time required to start power supply.

In addition, technical features other than the aforementioned characteristics of the present disclosure, which are described in each claim of the claims, will become apparent from the following description of the embodiments and the accompanying drawings.

Hereinafter, embodiments of the in-vehicle network system and the control method for the in-vehicle network system according to the present disclosure will be described with reference to the drawings. However, the present disclosure is not limited to the following embodiments, and various modifications described below are also included within the technical scope of the present disclosure. Furthermore, various modifications may be made without departing from the spirit of the present disclosure, in addition to those described below. The embodiments and various modifications can be appropriately combined and implemented as long as no technical contradictions arise. In the following description, identical or similar components may be assigned the same reference numerals across multiple drawings, and explanations thereof may be omitted. Additionally, when only a part of a configuration is mentioned, the explanation provided in other sections may be applied to the other parts.

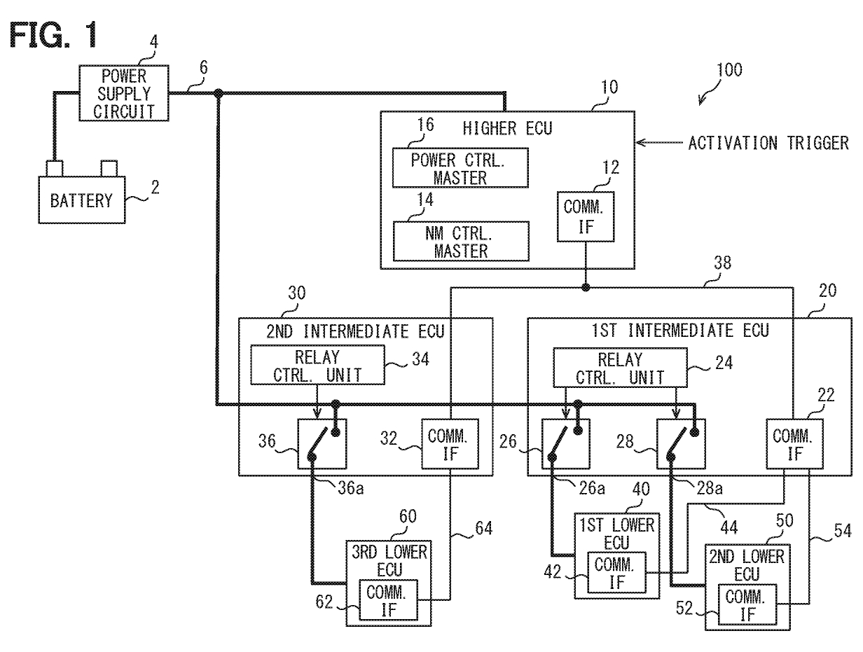

(First Embodiment) FIG. 1 is a diagram illustrating an example of the configuration of an in-vehicle network system 100 according to the present embodiment. The in-vehicle network system 100 shown in FIG. 1 includes a higher-level ECU 10 serving as a third controller, first and second intermediate ECUs 20 and 30 serving as second controllers, and first to third lower-level ECUs 40, 50, and 60 serving as first controllers. ECU is an abbreviation for Electronic Control Unit.

The in-vehicle network system 100 operates by receiving power supplied from a battery 2 installed in the vehicle. More specifically, power from the battery 2 is supplied to the higher-level ECU 10, the first and second intermediate ECUs 20 and 30, and the first to third lower-level ECUs 40, 50, and 60 of the in-vehicle network system 100 through a power supply circuit 4. The power supply circuit 4 can convert, as necessary, the supply voltage of the battery 2 installed in the vehicle into the operating voltages for the higher-level ECU 10, the first and second intermediate ECUs 20 and 30, and the first to third lower-level ECUs 40, 50, and 60. A power supply line 6 for the first to third lower-level ECUs 40, 50, and 60 is provided with first to third relay circuits 26, 28, and 36, whose on and off states are switched by the first and second intermediate ECUs 20 and 30.

The configuration of the in-vehicle network system 100 is not limited to the example shown in FIG. 1. For example, the number of higher-level ECUs 10 may be two or more, rather than just one. Additionally, any of the intermediate ECUs 20 or 30 may also serve as the higher-level ECU 10, in which case the higher-level ECU 10 may be omitted. The number of intermediate ECUs 20 and 30 may be one instead of two, or three or more. With respect to the lower-level ECUs 40, 50, and 60, multiple lower-level ECUs may be connected to a single relay circuit 26, 28, or 36. Additionally, the lower-level ECUs 40, 50, and 60 may include lower-level ECUs that are supplied with power directly from the power supply circuit 4 without passing through the relay circuits 26, 28, and 36.

The higher-level ECU 10, the first and second intermediate ECUs 20 and 30, and the first to third lower-level ECUs 40, 50, and 60 may each be formed of a computer equipped with a processor, memory, and storage. The processor may be a CPU (Central Processing Unit), MPU (Micro Processing Unit), GPU (Graphics Processing Unit), or DFP (Data Flow Processor), which executes predetermined processing in accordance with a program. The memory is a volatile storage medium, such as RAM (Random Access Memory), which temporarily stores processing results from the processor. The storage is a non-volatile storage medium, such as flash memory or ROM (Read Only Memory). Various programs and data executed by the processor are stored in the storage. Some or all of the functions provided by the higher-level ECU 10, the first and second intermediate ECUs 20 and 30, and the first to third lower-level ECUs 40, 50, and 60 may be implemented by hardware, for example, using an ASIC (Application Specific Integrated Circuit) or an FPGA (Field-Programmable Gate Array), instead of software such as programs.

Furthermore, the higher-level ECU 10, the first and second intermediate ECUs 20 and 30, and the first to third lower-level ECUs 40, 50, and 60 are each provided with a communication interface (communication IF) 12, 22, 32, 42, 52, and 62 for communicating with other ECUs via communication buses 38, 44, 54, and 64.

The communication IF 12 of the higher-level ECU 10 is connected to the communication IFs 22 and 32 of the first and second intermediate ECUs 20 and 30 via the communication bus 38. The first and second intermediate ECUs 20 and 30 can also communicate with each other via the communication bus 38. However, the communication bus that connects the higher-level ECU 10 with the first and second intermediate ECUs 20 and 30, and the communication bus that connects the first and second intermediate ECUs 20 and 30 with each other, may be provided separately. The communication IF 22 of the first intermediate ECU 20 is further connected to the communication IF 42 of the first lower-level ECU 40 via the communication bus 44. In addition, the communication IF 22 of the first intermediate ECU 20 is connected to the communication IF 52 of the second lower-level ECU 50 via the communication bus 54. The communication IF 42 of the first lower-level ECU 40 and the communication IF 52 of the second lower-level ECU 50 may be connected to the communication IF 22 of the first intermediate ECU 20 via a common communication bus. The communication IF 32 of the second intermediate ECU 30 is connected to the communication IF 62 of the third lower-level ECU 60. The communication IFs 22 and 32 of the first and second intermediate ECUs 20 and 30 may be configured to function as gateways when the higher-level ECU 10 and the first to third lower-level ECUs 40, 50, and 60, which are connected to different communication buses 38, 44, 54, and 64, communicate with each other.

The in-vehicle network system 100 can use CAN (registered trademark, the same applies hereinafter) as the communication protocol for enabling the respective communication IFs 12, 22, 32, 42, 52, and 62 of the higher-level ECU 10, the first and second intermediate ECUs 20 and 30, and the first to third lower-level ECUs 40, 50, and 60 to communicate with each other. CAN is an abbreviation for Controller Area Network. It should be noted that the communication protocol is not limited to CAN. The in-vehicle network system 100 can employ various communication protocols such as Ethernet (registered trademark), LIN (Local Interconnect Network), FlexRay (registered trademark), and CAN-FD (CAN with Flexible Data Rate). For example, different communication protocols may be adopted for the different communication buses 38, 44, 54, and 64.

The higher-level ECU 10 can have a function as a domain controller that supervises the control of the first and second intermediate ECUs 20 and 30 and the first to third lower-level ECUs 40, 50, and 60. A domain refers to a functional unit when the vehicle's functions are broadly categorized, such as a powertrain domain, chassis domain, advanced driver assistance domain, body domain, and cockpit domain. The above is merely one example of domain classification, and the domains may be classified differently from the examples described above. Alternatively, the higher-level ECU 10 may function as an area controller that oversees the control of the first and second intermediate ECUs 20 and 30, and the first to third lower-level ECUs 40, 50, and 60, arranged in an area of the vehicle.

In addition, the higher-level ECU 10 has an NM control master 14 that transmits an activation network management (hereinafter, NM) message as a Wakeup signal to the first and second intermediate ECUs 20 and 30, in response to an input of a predetermined activation trigger. The activation NM message will be described later. The predetermined activation trigger may be generated when the door lock of the vehicle is unlocked by operation of a portable key carried by the user or by operation of the door handle, when the main switch of the vehicle is turned on, or when a notification of a specified vehicle state is received from another higher-level ECU serving as a domain controller. The NM control master 14 can transmit an activation NM message that enables selective activation of the first intermediate ECU 20 and/or the second intermediate ECU 30 to the normal operation mode, depending on the cause of the activation trigger input.

Furthermore, the higher-level ECU 10 has a power supply control master 16 that instructs the first and second intermediate ECUs 20 and 30 to turn on the relay circuits 26, 28, and 36 corresponding to the lower-level ECUs 40, 50, and 60 that need to operate in the normal operation mode, based on the vehicle state (for example, states such as driving, stopped, or parked, or the state of various functions operated by the user) as determined from information acquired from sensors or other ECUs. Specifically, the power supply control master 16 transmits relay control messages to the first and second intermediate ECUs 20 and 30. The relay control message includes instructions regarding which of the relay circuits 26, 28, and 36 are to be turned on and/or which of the relay circuits 26, 28, and 36 are to remain turned off. The first and second intermediate ECUs 20 and 30 turn the respective relay circuits 26, 28, and 36 on or off based on the relay control message. In other words, the power supply control master 16 can individually instruct each of the intermediate ECUs 20 and 30 to turn the respective relay circuits 26, 28, and 36 on or off, with the relay control messages, according to the state of the vehicle.

The first intermediate ECU 20 has the first and second relay circuits 26 and 28, and the second intermediate ECU 30 has the third relay circuit 36. The first intermediate ECU 20 also has a first relay control unit 24 that turns the first and second relay circuits 26 and 28 on or off according to the activation NM message and the relay control message. The second intermediate ECU 30 has a second relay control unit 34 that turns the third relay circuit 36 on or off according to the activation NM message and the relay control message.

The first relay circuit 26 is provided on the power supply line 6 for supplying power to the first lower-level ECU 40. In other words, the power line of the first lower-level ECU 40 is connected to a first power port 26a, which is connected to the first relay circuit 26. The second relay circuit 28 is provided on the power supply line 6 for supplying power to the second lower-level ECU 50. In other words, the power line of the second lower-level ECU 50 is connected to a second power port 28a, which is connected to the second relay circuit 28. The third relay circuit 36 is provided on the power supply line 6 for supplying power to the third lower-level ECU 60. In other words, the power line of the third lower-level ECU 40 is connected to a third power port 36a, which is connected to the third relay circuit 36.

The first to third relay circuits 26, 28, and 36 may be formed of semiconductor switches such as MOSFETs or IGBTs. However, the first to third relay circuits 26, 28, and 36 may be formed of ordinary mechanical relays. Further, the first to third relay circuits 26, 28, and 36 may be provided inside the first and second intermediate ECUs 20 and 30 as shown in FIG. 1, or may be provided outside the first and second intermediate ECUs 20 and 30.

The first to third lower-level ECUs 40, 50, and 60 may be control ECUs that control predetermined control targets in a vehicle, or sensor ECUs that calculate predetermined physical quantities based on detection signals detected by sensors. The first to third lower-level ECUs 40, 50, and 60 are activated to a normal operation mode and execute the required processing when it is necessary to control a control target or when it is necessary to calculate a predetermined physical quantity based on a detection signal from a sensor. On the other hand, when it is not necessary for the first to third lower-level ECUs 40, 50, and 60 to control the control target or to calculate a predetermined physical quantity, the first to third lower-level ECUs 40, 50, and 60 enter a power cutoff state in a low-power consumption mode.

To achieve switching between the normal operation mode and the low-power consumption mode, the higher-level ECU 10, the first and second intermediate ECUs 20 and 30, and the first to third lower-level ECUs 40, 50, and 60 are each assigned to a cluster among multiple divided clusters. The assigned cluster is retained by each ECU as cluster configuration information (also referred to as PNC setting information). PNC is an abbreviation for Partial Networking Clustering. As will be described later, the PNC setting information for the first to third lower-level ECUs 40, 50, and 60 is stored in the storage (memory unit) of the corresponding intermediate ECUs 20 and 30. The NM message includes activation cluster information (also referred to as PN request information). In response to the activation cluster information including a request to activate the cluster to which the first to third lower-level ECUs 40, 50, and 60 belong, the intermediate ECUs 20 and 30 turn on the relay circuits 26, 28, and 36 connected to the first to third lower-level ECUs 40, 50, and 60 in the cluster. As a result, the first to third lower-level ECUs 40, 50, and 60 are switched from the low-power consumption mode, in which power supply is cut off, to the normal operation mode, in which power is supplied.

When the first to third lower-level ECUs 40, 50, and 60 are activated and enter the normal operation mode, the first to third lower-level ECUs periodically transmit NM messages to other ECUs while they are operating normally. After having performed the necessary processing, the first to third lower-level ECUs 40, 50, and 60 stop transmitting NM messages when it becomes unnecessary to execute the normal operation. The first and second intermediate ECUs 20 and 30 monitor the NM messages addressed to the first to third lower-level ECUs 40, 50, and 60. Then, when no NM messages addressed to the first to third lower-level ECUs 40, 50, and 60 are received for a predetermined waiting time, the first and second intermediate ECUs 20 and 30 turn off the first to third relay circuits 26, 28, and 36, thereby stopping the power supply to the first to third lower-level ECUs 40, 50, and 60.

As described above, in the in-vehicle network system 100 of the present embodiment, the higher-level ECU 10, the first and second intermediate ECUs 20 and 30, and the first to third lower-level ECUs 40, 50, and 60 are classified into multiple groups (hereinafter referred to as clusters). Each group includes ECUs that needs to be activated simultaneously in order to realize at least one desired function. Switching between the normal operation mode (active state) and the low-power consumption mode (sleep state or power cutoff state) is realized for each cluster with the NM messages. It should be noted that the higher-level ECU 10 and the first and second intermediate ECUs 20 and 30 can enter the low-power consumption mode. In the low-power consumption mode, the first and second intermediate ECUs 20 and 30 may have only reception function for predetermined Wakeup signals, such as the activation NM message, which is described later, and other operations are stopped or power supply to circuit sections that perform other operations is cut off. As a result, it is possible to reduce power consumption in the first and second intermediate ECUs 20 and 30 while waiting for a Wakeup signal.

The following provides a detailed explanation of an example of the NM message, PN request information, and PNC setting information.

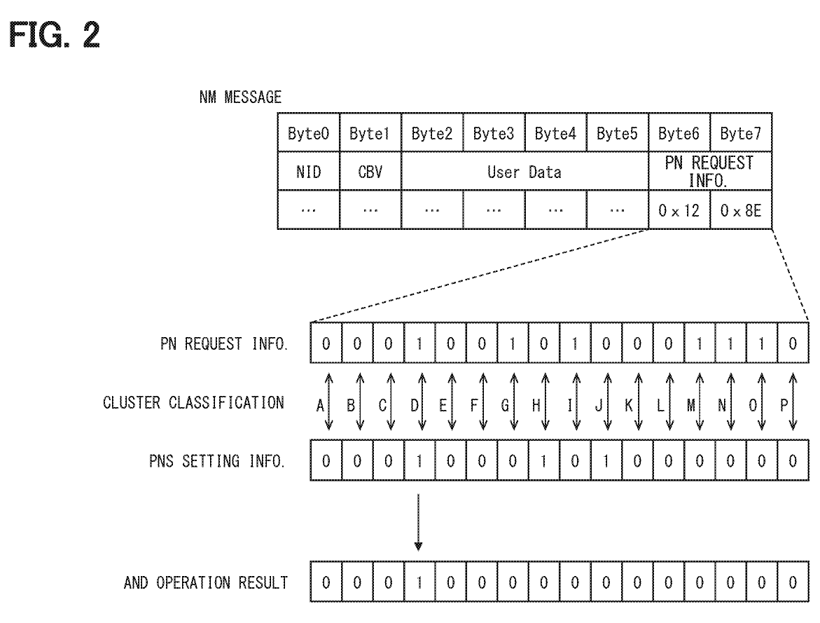

The NM message may include data from byte 0 to byte 7, as shown in FIG. 2. Byte 0 contains a Node ID (NID). The Node ID is a unique identifier assigned to each of the higher-level ECU 10, the first and second intermediate ECUs 20 and 30, and the first to third lower-level ECUs 40, 50, and 60. The node ID enables identification of a transmission source of the NM message. Byte 1 contains a Control Bit Vector (CBV). The Control Bit Vector is data that indicates whether partial networking is used. When the Control Bit Vector indicates the use of partial networking, the user data area of bytes 2 to 7 contains PN request information, which is activation cluster information indicating the cluster to be activated. It should be noted that partial networking refers to a state in which only ECUs belonging to one or some clusters are activated, while the other ECUs belonging to the remaining clusters are placed in a power-off state or a sleep state. By activating only ECUs that need to operate as described above, it is possible to reduce the power consumption of ECUs installed in the vehicle.

In the example shown in FIG. 2, the Control Bit Vector indicates the use of partial networking, and the PN request information is stored in bytes 6 and 7 of the user data area. The user data area of bytes 2 to 5 may be used to transmit arbitrary information such as activation factors of ECU or information regarding normal or abnormal conditions. It should be noted that FIG. 2 is merely an example of the format of an NM message, and the NM message may take other formats as long as it includes information indicating whether partial networking is used and the PN request information. For example, the positions of the NID and CBV may be reversed.

The PN request information indicates which clusters should be activated and which clusters do not need to be activated for each of the multiple divided clusters. More specifically, in the example shown in FIG. 2, the ECUs are classified into 16 clusters in advance. The PN request information includes 16-bit data corresponding to the 16 clusters. That is, the 16-bit data of the PN request information is associated with the 16 clusters in advance. When a bit in 16-bit data of the PN request information is "0", the data indicates that activation of the corresponding cluster is not required. When a bit in 16-bit data of the PN request information is "1", the data indicates that activation of the corresponding cluster is required. It should be noted that the PN request information may indicate only the clusters that need to be activated. Alternatively, the PN request information may indicate only the clusters that do not need to be activated.

The higher-level ECU 10, the first and second intermediate ECUs 20 and 30, and the first to third lower-level ECUs 40, 50, and 60 each have PNC setting information indicating the cluster to which they belong, as described above. An example of the PNC setting information is shown in FIG. 2. That is, FIG. 2 shows an example of the PNC setting information held by any one of the higher-level ECU 10, the first and second intermediate ECUs 20 and 30, and the first to third lower-level ECUs 40, 50, and 60. The PNC setting information shown in FIG. 2 indicates, when the associated clusters are classified as A to P from the left to the right, that the ECU having the PNC setting information belongs to clusters D, H, and J. Since the first to third lower-level ECUs 40, 50, and 60 can exhibit various functions through program execution, they may belong to one or more clusters.

The higher-level ECU 10, and the first and second intermediate ECUs 20 and 30 can each receive an NM message including PN request information via their respective communication IFs 12, 22, and 32. Upon receiving an NM message, the higher-level ECU 10 and the first and second intermediate ECUs 20 and 30 compare the PN request information and the PNC setting information bit by bit as shown in FIG. 2, and may calculate the logical AND. The higher-level ECU 10 and the first and second intermediate ECUs 20 and 30 enter the normal operation mode through a predetermined activation process upon receiving an NM message at their respective communication IFs 12, 22, and 32 in the low-power consumption mode.

The higher-level ECU 10 and the first and second intermediate ECUs 20 and 30 determine whether the cluster for which activation is requested by the PN request information included in the NM message matches the cluster indicated by the PNC setting information. For example, in the example shown in FIG. 2, the clusters for which activation is requested by the PN request information are clusters D, G, I, M, N, and O. The clusters to which the ECU belongs, as indicated by the PNC setting information, are clusters D, H, and J. In this case, in cluster D, the cluster for which activation is requested by the PN request information included in the NM message matches the cluster indicated by the PNC setting information. As shown in FIG. 2, the result of the logical AND operation is “1” for cluster D.

If the logical AND operation results in any bit being in “1”, the ECU having the PNC setting information shown in FIG. 2 determines that activation of itself has been requested. In response to this determination result, the ECU having the PNC setting information shown in FIG. 2 transitions from the low-power consumption mode to the normal operation mode. If the ECU has already been in the normal operation mode, the ECU maintains the normal operation mode. On the other hand, when none of the bits is “1” and all are “0” as a result of the logical AND operation, the ECU having the PNC setting information shown in FIG. 2 determines that activation of itself has not been requested. In this case, the ECU discards the received NM message and returns to the low-power consumption mode again.

As described above, the higher-level ECU 10 and the first and second intermediate ECUs 20 and 30 have a function of identifying whether an NM message is requesting activation of themselves based on the PNC setting information. The function of identifying the NM message enables only ECUs, among the higher-level ECU 10 and the first and second intermediate ECUs 20 and 30, having the PNC setting information including clusters for which the PN request information requests activation to enter the normal operation mode by the NM message.

In the present embodiment, when an activation trigger occurs, the NM message is used as a Wakeup signal to transition the first and second intermediate ECUs 20 and 30 from the low-power consumption mode to the normal operation mode. For example, when the first and second intermediate ECUs 20 and 30 transition from the low-power consumption mode to the normal operation mode in response to a signal of a predetermined level, the activation NM message is defined to include the predetermined level signal. Furthermore, when the first and second intermediate ECUs 20 and 30 transition from the low-power consumption mode to the normal operation mode in response to the communication IFs 22 and 32 of the first and second intermediate ECUs 20 and 30 receiving an NM message addressed to the intermediate ECUs as the destination, the activation NM message is defined to include information containing the first and second intermediate ECUs 20 and 30 as the destination. In the present embodiment, an NM message that causes the first and second intermediate ECUs 20 and 30 to transition from the low-power consumption mode to the normal operation mode when an activation trigger occurs is referred to as an activation NM message. It should be noted that the higher-level ECU 10 may be configured not to enter the low-power consumption mode and may always operate in the normal operation mode.

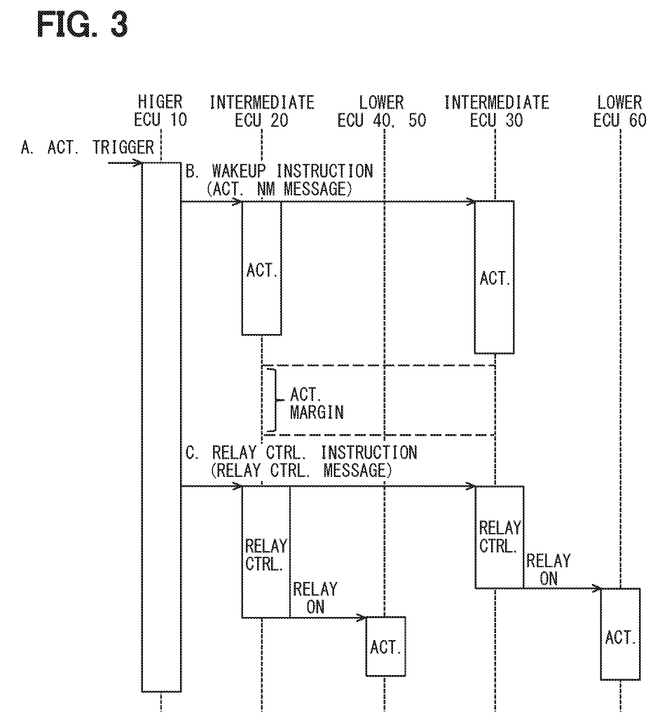

Here, when the first and second intermediate ECUs 20 and 30, which have the function of switching the supply and cutoff of power to the first to third lower-level ECUs 40, 50, and 60, are in the low-power consumption mode such as the sleep state or the power cutoff state, it is necessary for the first and second intermediate ECUs 20 and 30 to first perform a predetermined activation process and transition to the normal operation mode in response to receiving an activation NM message instructing a Wakeup from the NM control master 14, as shown in FIG. 3. FIG. 3 shows an example in which the first and second intermediate ECUs 20 and 30 are activated by an activation NM message and enters the normal operation mode. Furthermore, through relay control processing, the first and second intermediate ECUs 20 and 30 turn on the first to third relay circuits 26, 28, and 36, thereby starting the supply of power to the first to third lower-level ECUs 40, 50, and 60.

During execution of the predetermined activation process, the first and second intermediate ECUs 20 and 30 are unable to receive relay control messages from the power supply control master 16. In other words, the first and second intermediate ECUs cannot decode the relay control messages and thus cannot determine which of the relay circuits 26, 28, and 36 should be turned on. Thus, as shown in FIG. 3, the power supply control master 16 needs to transmit the relay control message after the activation processes have been completed in all the intermediate ECUs 20 and 30 and the intermediate ECUs has entered the normal operation mode. For example, the power supply control master 16 transmit the relay control message after a predetermined activation margin has elapsed. The first and second intermediate ECUs 20 and 30 in the normal operation mode can receive the relay control message.

As shown in FIG. 3, the first and second intermediate ECUs 20 and 30 having received the relay control message decode the relay control message and, based on the decoded relay control message, drive the first and second relay control units 24 and 34 to execute relay control processing in which the first to third relay circuits 26, 28, and 36 are turned on or off. As a result, power supply to the first to third lower-level ECUs 40, 50, and 60, corresponding to the relay circuits 26, 28, and 36 that have been turned on, is initiated. The first to third lower-level ECUs 40, 50, and 60, to which power supply has been initiated, undergo predetermined activation processing and then operate in the normal operation mode.

As in the example shown in FIG. 3, when the first and second intermediate ECUs 20 and 30 are in the low-power consumption mode, a relatively long time is required to start power supply to the first to third lower-level ECUs 40, 50, and 60 after the occurrence of the activation trigger.

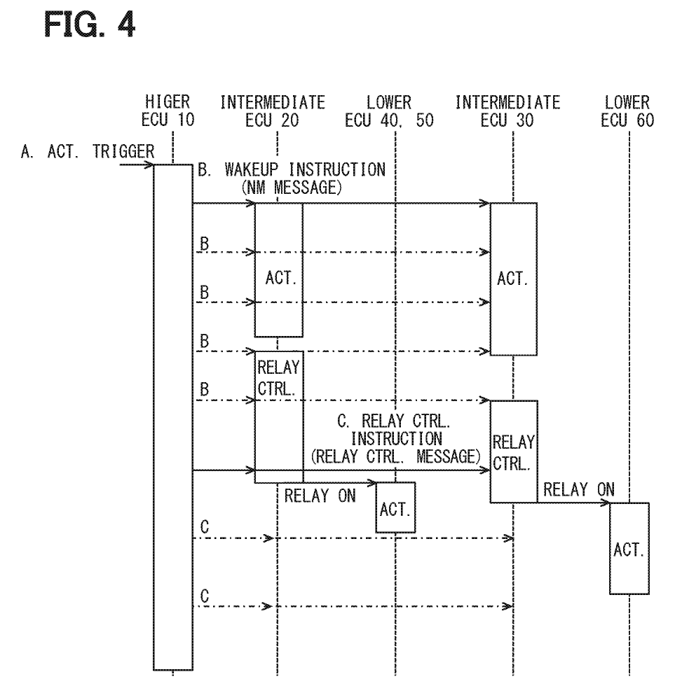

Thus, in the in-vehicle network system 100 according to the present embodiment, the NM control master 14 is configured to, in response to the occurrence of an activation trigger, transmit an activation NM message to the first and second intermediate ECUs 20 and 30 that are in the low power consumption mode. The activation NM message includes a selective instruction (the PN request information) for selectively activating the first to third lower-level ECUs 40, 50, and 60. As shown in FIG. 4, when the first and second intermediate ECUs 20 and 30 enters the normal operation mode in response to the activation NM message, the first and second intermediate ECUs 20 and 30 execute the relay control to turn on or off the first to third relay circuits 26, 28, and 36, based on the selective instructions included in the activation NM message for selectively activating the first to third lower-level ECUs 40, 50, and 60. Thus, as shown in FIG. 4, the relay control can be started before the relay control message is transmitted to the first and second intermediate ECUs 20 and 30 by the power supply control master 16, thereby enabling the power supply to the first to third lower-level ECUs 40, 50, and 60 to be initiated earlier. As a result, it becomes possible to shorten the time from the occurrence of the activation trigger to the initiation of power supply to the first to third lower-level ECUs 40, 50, and 60.

It should be noted that, as shown in FIG. 4, the NM control master 14 may repeatedly transmit the activation NM message at predetermined intervals until the relay control message is provided to the first and second intermediate ECUs 20 and 30 by the power supply control master 16. As a result, when the first and second intermediate ECUs 20 and 30 are activated by the activation NM message and enter the normal operation mode, the first and second intermediate ECUs 20 and 30 can decode the instructions included in subsequently received activation NM messages, and, based on the decoded instructions, turn the first to third relay circuits 26, 28, and 36 on or off. Further, after all the intermediate ECUs 20 and 30 have been activated by the activation NM message that is firstly transmitted, activation NM messages may be repeatedly transmitted to the intermediate ECUs 20 and 30 that should remain in the normal operation mode. As a result, only the intermediate ECUs that need to operate in the normal operation mode can remain in the normal operation mode, while the other intermediate ECUs can be returned to the low-power consumption mode.

However, the NM control master 14 does not necessarily have to repeatedly transmit the activation NM message at predetermined intervals. For example, if the communication IFs 22 and 32 of the first and second intermediate ECUs 20 and 30 have a function to store the activation NM message, the first and second intermediate ECUs 20 and 30 can obtain selective activation instructions for the first to third lower-level ECUs 40, 50, and 60 from the stored activation NM message after being activated and enter the normal operation mode.

The configuration for turning the first to third relay circuits 26, 28, and 36 on or off, by the first and second intermediate ECUs 20 based on the activation NM message that includes selective activation instructions for the first to third lower-level ECUs 40, 50, and 60, will be described below.

The storage of the first and second intermediate ECUs 20 and 30 stores the PNC setting information indicating the cluster to which the first to third lower-level ECUs 40, 50, and 60 belong, in addition to programs executed by the processors of the first and second intermediate ECUs 20 and 30. Each of the first to third lower-level ECUs are classified to at least one cluster. Furthermore, the storage of the first and second intermediate ECUs 20 and 30 store relay connection information indicating the correspondence between the first to third relay circuits 26, 28, and 36 and the first to third lower-level ECUs 40, 50, and 60.

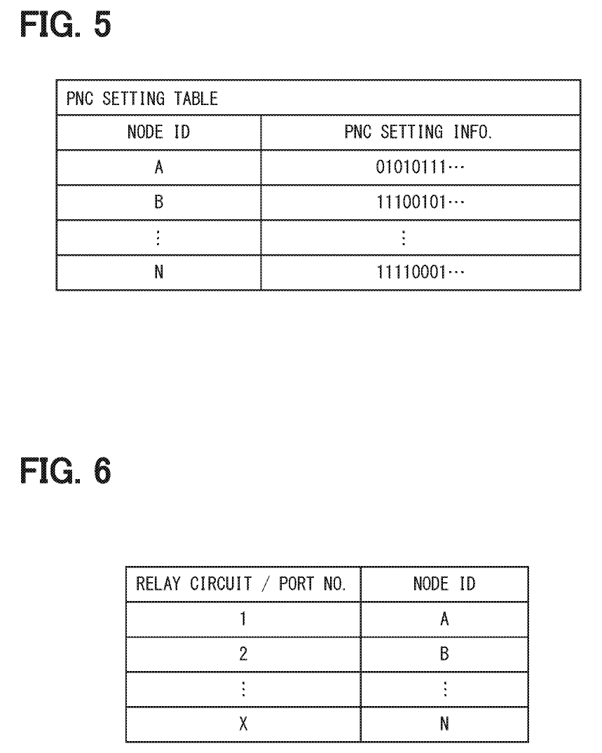

For example, the storage of the first and second intermediate ECUs 20 and 30 may store the PNC setting information indicating the clusters assigned to each of the first to third lower-level ECUs 40, 50, and 60 in a form of a PNC setting table as shown in FIG. 5. It should be noted that the PNC setting table illustrated in FIG. 5 shows the correspondence between the node IDs, which are unique identifiers for the lower-level ECUs including the first to third lower-level ECUs 40, 50, and 60, and the PNC setting information assigned to the lower-level ECUs including the first to third lower-level ECUs 40, 50, and 60.

In addition, the storage of the first and second intermediate ECUs 20 and 30 store, as relay connection information, the correspondence between the identification numbers of the relay circuits, including the first to third relay circuits 26, 28, and 36, or the identification numbers of power ports, and the node IDs, which are unique identifiers of the lower-level ECUs including the first to third lower-level ECUs 40, 50, and 60, as illustrated in FIG. 6.

The first and second intermediate ECUs 20 and 30 having entered the normal operation mode can acquire the PNC setting information for each of the first to third lower-level ECUs 40, 50, and 60 by referring to the PNC setting table illustrated in FIG. 5. Then, based on the acquired PNC setting information for the first to third lower-level ECUs 40, 50, and 60, and the PNC request information included in the activation NM message, the first and second intermediate ECUs 20 and 30 can determine, from the activation NM message, which of the lower-level ECUs 40, 50, and 60 has been instructed to start.

Specifically, the first and second intermediate ECUs 20 and 30 compare the PNC request information included in the activation NM message with the PNC setting information of each of the lower-level ECUs 40, 50, and 60, on a bit-by-bit basis. Then, when the first and second intermediate ECUs 20 and 30 determine, based on the comparison results, that there is a PNC setting information that includes a cluster for which activation has been requested by the PNC request information, the first and second intermediate ECUs 20 and 30 determine that activation of the lower-level ECU 40, 50, or 60 having the PNC setting information has been instructed. In this case, the first and second intermediate ECUs 20 and 30 can determine which relay circuits should be turned on and which should be turned off by referring to the relay connection information illustrated in FIG. 6, based on the node ID indicating the lower-level ECU 40, 50, or 60 for which activation has been instructed by the activation NM message. On the other hand, when the first and second intermediate ECUs 20 and 30 determine that there is no PNC setting information including a cluster for which activation has been requested by the PNC request information, the received activation NM message does not instruct activation of any of the lower-level ECUs 40, 50, or 60, and therefore all relay circuits 26, 28, and 36 are kept turned off.

When the first and second intermediate ECUs 20 and 30 have determined which relay circuits should be turned on and which should be turned off, they drive the first and second relay control units 24 and 34 to turn on the relay circuits 26, 28, and 36 corresponding to the relay circuits that should be turned on. By executing such relay control processing, power is supplied to the lower-level ECUs 40, 50, and 60 for which activation has been instructed by the activation NM message via the corresponding first to third relay circuits 26, 28, and 36, thereby switching the lower-level ECUs 40, 50, and 60 to the normal operation mode.

As described above, the first to third lower-level ECUs 40, 50, and 60 control target devices, such as door lock mechanisms, power window drive motors, headlight light sources, wiper motors, and AV equipment, that are installed in the vehicle and controlled only when specific conditions are met or under specific environments, or perform calculations of predetermined physical quantities required for such control based on detection signals from sensors. For example, the door lock mechanism is controlled by an ECU for door lock control when a vehicle user wants to enter or exit the vehicle. The drive motor for the power window is controlled by the ECU for power window control when the window lift switch is operated by the user.

In this manner, the first to third lower-level ECUs 40, 50, and 60 control target devices that operate only when specific conditions are met or under specific environments, or calculate predetermined physical quantities required for such control. Thus, when the activation of the first to third lower-level ECUs 40, 50, and 60 is instructed by an activation NM message, the first and second intermediate ECUs 20 and 30 turn on the first to third relay circuits 26, 28, and 36 corresponding to the first to third lower-level ECUs 40, 50, and 60, thereby supplying power to the first to third lower-level ECUs 40, 50, and 60. As a result, the necessary processing can be started within a short time after the activation is instructed. When the activation of the first to third lower-level ECUs 40, 50, and 60 is not instructed by an activation NM message, the first and second intermediate ECUs 20 and 30 turn off the first to third relay circuits 26, 28, and 36, thereby stopping the supply of power to the first to third lower-level ECUs 40, 50, and 60. As a result, the dark current is cut off when the operation of the lower-level ECUs 40, 50, and 60 is unnecessary, thereby enabling further power savings for the entire in-vehicle system.

The activation NM message may be generated by the NM control master 14 of the higher-level ECU 10, as a function of a domain controller or area controller. However, the function of transmitting an activation NM message in response to a predetermined activation trigger may be provided not only in the higher-level ECU 10, but additionally or alternatively, in another higher-level ECU, the first and second intermediate ECUs 20 and 30, and/or at least one of other ECUs such as the first to third lower-level ECUs 40, 50, and 60. In other words, multiple NM control masters 14 may be provided in the in-vehicle network system. For example, when one of the first and second intermediate ECUs 20 and 30 is operating in the normal operation mode and the other is in the low-power consumption mode, the intermediate ECU operating in the normal operation mode may transmit an activation NM message to the intermediate ECU that is in the low-power consumption mode. In this case, the intermediate ECU operating in the normal operation mode corresponds to a third controller.

When the first and second intermediate ECUs 20 and 30 receive activation NM messages from multiple ECUs (i.e., NM control masters) at the same time, the first and second intermediate ECUs 20 and 30 may turn on the first to third relay circuits 26, 28, and 36 if any of the received activation NM messages instructs the activation of the corresponding first to third lower-level ECUs 40, 50, and 60. As a result, even when multiple NM control masters are provided in the in-vehicle network system 100, power can be appropriately supplied to the first to third lower-level ECUs 40, 50, and 60.

Furthermore, when the first and second intermediate ECUs 20 and 30 turn on at least one of the first to third relay circuits 26, 28, and 36 based on the instructions included in the activation NM message, the first and second intermediate ECUs 20 and 30 may keep the corresponding first to third relay circuits 26, 28, and 36 turned on for a predetermined period. The duration for which the relay circuits 26, 28, and 36 are turned on may be the period until the power supply control master 16 starts transmitting the relay control message after the first and second intermediate ECUs 20 and 30 enter the normal operation mode.

As described above, the power supply control master 16 determines functions to be executed in the vehicle according to the state of the vehicle, based on various sensor signals and information obtained from other ECUs. Then, when the power supply control master 16 determines that at least one of the first to third lower-level ECUs 40, 50, and 60 needs to operate in the normal operation mode, the power supply control master transmits a relay control message instructing the corresponding relay circuit 26, 28, or 36 to turn on. When the power supply control master 16 determines that the first to third lower-level ECUs 40, 50, and 60 do not need to operate in the normal operation mode, the power supply control master 16 transmits a relay control message instructing the first to third relay circuits 26, 28, and 36 to turn off.

In this way, the power supply control master 16 determines, based on the state of the vehicle, whether the first to third relay circuits 26, 28, and 36 should be turned on or off, and provides this instruction to the first and second intermediate ECUs 20 and 30 via a relay control message. Accordingly, after the relay control message is provided to the first and second intermediate ECUs 20 and 30 by the power supply control master 16, the first and second intermediate ECUs 20 and 30 may give priority to the instruction from the relay control message over the instruction from the activation NM message, and to turn the first to third relay circuits 26, 28, and 36 on or off accordingly.

Specifically, until the relay control message is provided, the first and second intermediate ECUs 20 and 30 turn the first to third relay circuits 26, 28, and 36 on or off based on the instruction from the activation NM message. However, when the first and second intermediate ECUs 20 and 30 receive the relay control message, they again turn the first to third relay circuits 26, 28, and 36 on or off based on the instructions in the relay control message.

Here, due to certain factors, the relay control message from the power supply control master 16 may not reach the first and second intermediate ECUs 20 and 30 at the scheduled timing, even after the first and second intermediate ECUs 20 and 30 enter the normal operation mode. When the relay control message cannot be obtained, the relay circuits 26, 28, and 36, which do not originally need to be turned on, may remain on. In this regard, as described above, the first and second intermediate ECUs 20 and 30 turns on the corresponding first to third relay circuits 26, 28, and 36 based on the instructions included in the activation NM message, and keep the first to third relay circuits 26, 28, and 36 turned on for only a predetermined period. Thus, it is possible to prevent the relay circuits 26, 28, and 36 that do not need to be turned on from remaining on.

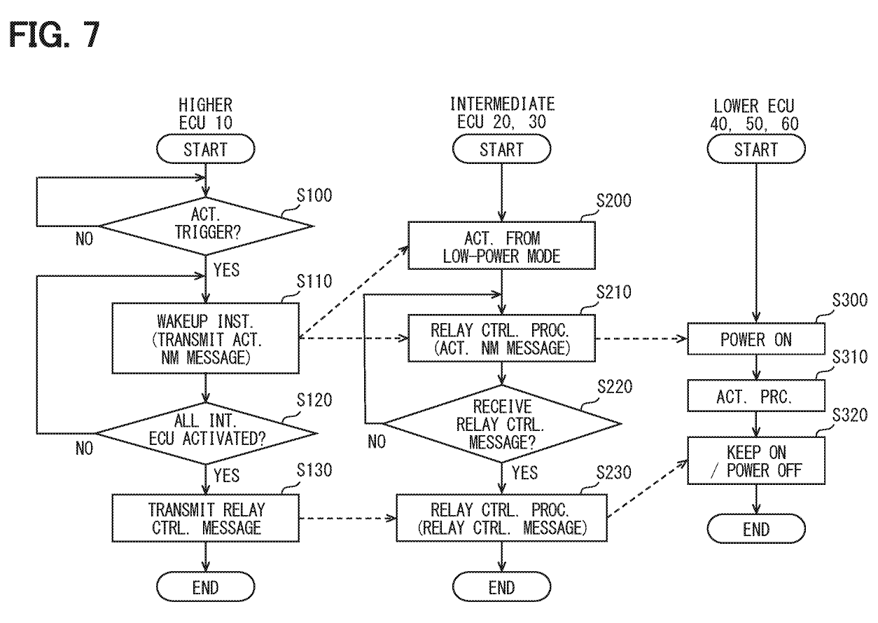

Next, with reference to the flowchart in FIG. 7, an example of the processing executed in the higher-level ECU 10, the first and second intermediate ECUs 20 and 30, and the first to third lower-level ECUs 40, 50, and 60 in response to the occurrence of an activation trigger will be described. It should be noted that the higher-level ECU 10, the first and second intermediate ECUs 20 and 30, and the first to third lower-level ECUs 40, 50, and 60 each executing the processes shown in the flowchart of FIG. 7 corresponds to executing the control method for the in-vehicle network system according to the present disclosure.

In step S100, the higher-level ECU 10 determines whether an activation trigger has occurred. If it is determined that an activation trigger has occurred, the higher-level ECU 10 proceeds the processing to step S110. If it is determined that an activation trigger has not occurred, the higher-level ECU 10 repeats the processing of step S100.

In step S110, a Wakeup instruction, that is, an activation NM message, is transmitted to the first and second intermediate ECUs 20 and 30. The activation NM message includes selective activation instructions (i.e., the PN request information) for the first to third lower-level ECUs 40, 50, and 60. In step S120, it is determined whether the activation of all intermediate ECUs 20 and 30 has been completed and whether they have entered the normal operation mode. For example, the higher-level ECU 10 can determine whether the activation of all intermediate ECUs 20 and 30 has been completed based on whether a predetermined period, which is longer than the activation processing time required by the intermediate ECU that takes the longest time for activation, has elapsed. If it is determined that the activation of all intermediate ECUs 20 and 30 has not been completed, the higher-level ECU 10 returns to the processing of step S110. Accordingly, the processing of step S110 is repeatedly executed until it is determined that the activation of all intermediate ECUs 20 and 30 has been completed. As a result, activation NM messages can be repeatedly transmitted at predetermined intervals from the higher-level ECU 10.

If it is determined that the activation of all intermediate ECUs 20 and 30 has been completed in step S120, the higher-level ECU 10 proceeds the processing to step S130. In step S130, a relay control message instructing the turning on or off of the first to third relay circuits 26, 28, and 36 is transmitted based on the state of the vehicle. With the above, the processing of the higher-level ECU 10 in response to the occurrence of the activation trigger is completed. Thereafter, although not shown in the figures, the higher-level ECU 10 repeatedly transmits relay control messages at predetermined intervals according to the latest state of the vehicle.

The first and second intermediate ECUs 20 and 30 execute an activation process in step S200 to transition from the low-power consumption mode to the normal operation mode in response to receiving the activation NM message. After transitioning to the normal operation mode through this activation process, in step S210, the first and second intermediate ECUs 20 and 30 receive the activation NM messages repeatedly transmitted at predetermined intervals from the higher-level ECU 10. Then, the first and second intermediate ECUs 20 and 30 decode the PN request information included in the received activation NM message, and execute relay control processing based on the decoded PN request information. It should be noted that the higher-level ECU 10 does not necessarily have to repeatedly transmit the activation NM message. The first and second intermediate ECUs 20 and 30 may also store instructions for selective activation of the lower-level ECUs 40, 50, and 60 included in the previously received activation NM message.

In step S220, the first and second intermediate ECUs 20 and 30 determine whether or not they have received a relay control message from the higher-level ECU 10. If it is determined that a relay control message has been received, the first and second intermediate ECUs 20 and 30 proceed the processing to step S230. If it is determined that a relay control message has not been received, the first and second intermediate ECUs 20 and 30 return to the processing of step S210 and continue the relay control processing in accordance with the activation NM message.

In step S230, the first and second intermediate ECUs 20 and 30 execute relay control processing to turn on or off the first to third relay circuits 26, 28, and 36 in accordance with the received relay control message.

The first to third lower-level ECUs 40, 50, and 60, in step S300, start receiving power supply when relay control processing is executed by the first and second intermediate ECUs 20 and 30 and the corresponding first to third relay circuits 26, 28, and 36 are turned on. In step S310, the first to third lower-level ECUs 40, 50, and 60, to which power supply has started, execute predetermined activation processing. As a result, the first to third lower-level ECUs 40, 50, and 60 enter the normal operation mode.

In step S320, power supply to the first to third lower-level ECUs 40, 50, and 60 is maintained or stopped by the relay control processing in the first and second intermediate ECUs 20 and 30 in accordance with the relay control message.

As described above, in the present embodiment, the NM control master 14 transmits an activation NM message to the first and second intermediate ECUs 20 and 30, which are in the low-power consumption mode, in response to the occurrence of an activation trigger. The activation NM message enables the first and second intermediate ECUs 20 and 30 to transition from the low-power consumption mode to the normal operation mode. The activation NM message includes a selective instruction for selectively activating the first to third lower-level ECUs 40, 50, and 60. Thus, until the relay control message is provided by the power supply control master 16, the first and second intermediate ECUs 20 and 30 can turn the first to third relay circuits 26, 28, and 36 on or off based on the instructions included in the activation NM message. As a result, it is possible to perform processing for starting the power supply to the first to third lower-level ECUs 40, 50, and 60 even before the relay control message is provided to the first and second intermediate ECUs 20 and 30, thereby enabling a reduction in the time required to start power supply.

(Second Embodiment) Next, an in-vehicle network system and a control method for the in-vehicle network system of the second embodiment according to the present disclosure will be described. The in-vehicle network system according to the present embodiment is configured in the same manner as the in-vehicle network system 100 of the first embodiment. Accordingly, a description of the configuration of the in-vehicle network system according to the present embodiment will be omitted.

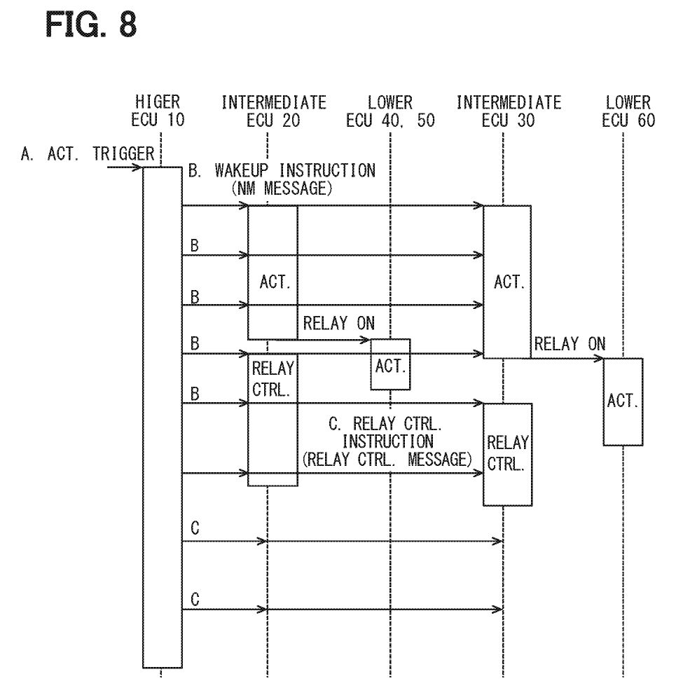

Also in the in-vehicle network system 100 according to the present embodiment, as shown in FIG. 8, the higher-level ECU 10 transmits, to the first and second intermediate ECUs 20, 30 in the low-power consumption mode, an activation NM message, which includes a selective instruction (i.e., the PN request information) for selectively activating the first to third lower-level ECUs 40, 50, 60, in response to the occurrence of an activation trigger. This point is the same as in the in-vehicle network system 100 of the first embodiment.

However, in the in-vehicle network system 100 according to the present embodiment, when the first and second intermediate ECUs 20 and 30 entered the normal operation mode in response to the activation NM message, as shown in FIG. 8, the first and second intermediate ECUs 20 and 30 turn on the first to third relay circuits 26, 28, and 36 before decoding the selective instructions for selectively activating the first to third lower-level ECUs 40, 50, and 60 included in the activation NM message (including activation NM messages received after having entered the normal operation mode). FIG. 8 shows an example in which the first and second intermediate ECUs 20 and 30 turn on the first to third relay circuits 26, 28, and 36 immediately after having entered the normal operation mode. However, the first and second intermediate ECUs 20 and 30 may turn on the first to third relay circuits 26, 28, and 36 at any timing before decoding the activation NM message.

Then, after having entered the normal operation mode, the first and second intermediate ECUs 20 and 30 execute relay control processing based on the selective instructions for selectively activating the first to third lower-level ECUs 40, 50, and 60 included in the activation NM message, as shown in FIG. 8. In this relay control processing, first, the selective instructions for activating the first to third lower-level ECUs 40, 50, and 60 included in the activation NM message are decoded. That is, the first and second intermediate ECUs 20 and 30 compare, bit by bit, the PN request information included in the activation NM message with the PNC setting information of each of the lower-level ECUs 40, 50, and 60. Then, when the first and second intermediate ECUs 20 and 30 determine, based on the comparison results, that there is the PNC setting information that includes a cluster for which activation has been requested by the PNC request information, the first and second intermediate ECUs 20 and 30 determine that activation of the lower-level ECU 40, 50, or 60 having the PNC setting information has been instructed.

Furthermore, as part of the relay control processing, the first and second intermediate ECUs 20 and 30 refer to the relay connection information based on the node IDs indicating the lower-level ECUs 40, 50, and 60 whose activation has been instructed by the activation NM message, and determine which relay circuits should be turned on and which relay circuits should be turned off. Then, the first and second intermediate ECUs 20 and 30 drive the first and second relay control units 24 and 34 to turn on the relay circuits 26, 28, and 36 that should be turned on, and to turn off the relay circuits 26, 28, and 36 that should be turned off.

As a result, the relay circuits 26, 28, and 36 that should be turned on remain in the ON state. Conversely, the relay circuits 26, 28, and 36 that should be turned off are switched from ON to OFF.

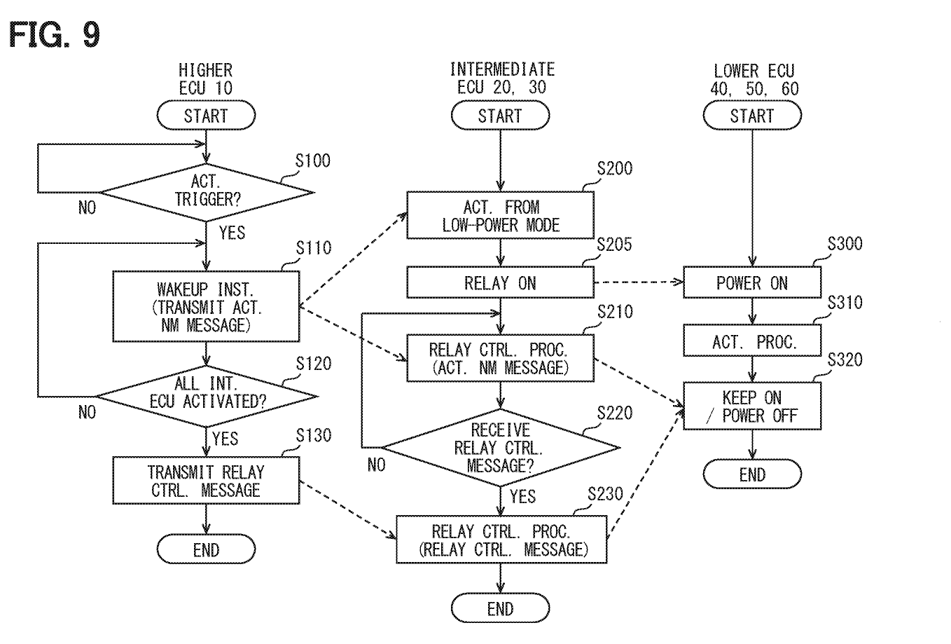

FIG. 9 is a flowchart illustrating an example of processing executed in the higher-level ECU 10, the first and second intermediate ECUs 20 and 30, and the first to third lower-level ECUs 40, 50, and 60 of the in-vehicle network system 100 according to the present embodiment, in response to the occurrence of an activation trigger. In the flowchart of FIG. 9, step S205 is added to the flowchart of FIG. 7. The other steps are the same in the flowcharts of FIG. 7 and FIG. 9, and therefore, description thereof will be omitted.

Step S205 is executed by the first and second intermediate ECUs 20 and 30 having entered the normal operation mode through the activation process. In step S205, the first and second intermediate ECUs 20 and 30 turn on the first to third relay circuits 26, 28, and 36. That is, after having entered the normal operation mode, the first and second intermediate ECUs 20 and 30 turn on all of the relay circuits 26, 28, and 36 regardless of the instructions included in the activation NM message. Thereafter, in step S210, the first and second intermediate ECUs 20 and 30 execute relay control processing in accordance with the activation NM message.

As described above, according to the in-vehicle network system 100 of the present embodiment, after having entered the normal operation mode, the first and second intermediate ECUs 20 and 30 turn on the first to third relay circuits 26, 28, and 36 before decoding the selective activation instructions for the first to third lower-level ECUs 40, 50, and 60 included in the activation NM message. As a result, power supply to the first to third lower-level ECUs 40, 50, and 60 can be started at an earlier stage.

Furthermore, according to the in-vehicle network system 100 of the present embodiment, relay control processing based on the selective activation instructions for the first to third lower-level ECUs 40, 50, and 60 included in the activation NM message is executed. As a result, even if the first to third relay circuits 26, 28, and 36 are turned on after having entered to the normal operation mode, any of the relay circuits 26, 28, and 36 that do not need to remain on are turned off by the relay control processing. Therefore, the on/off states of the first to third lower-level ECUs 40, 50, and 60 can be appropriately controlled.

(Modification Example) The preferred embodiments of the present disclosure have been described above. However, the present disclosure is not limited to the embodiments described above and may be implemented with various modifications without departing from the spirit of the present disclosure.

(Modification Example 1) For example, in the above-described embodiment, the higher-level ECU 10 has one NM control master 14 and one power supply control master 16. However, in consideration of the occurrence of abnormalities in the NM control master 14 and the power supply control master 16, multiple NM control masters 14 and power supply control masters 16 may be provided.

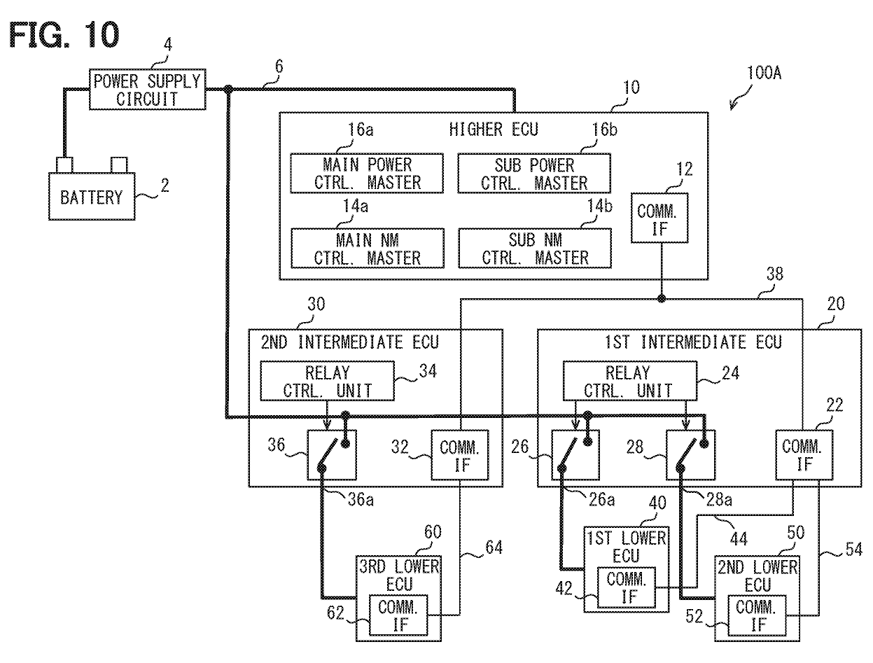

FIG. 10 shows an example of an in-vehicle network system 100A in which the higher-level ECU 10 is provided with a main NM control master 14a and a sub NM control master 14b, as well as a main power supply control master 16a and a sub power supply control master 16b. It should be noted that, in cases where an NM control master is provided in an ECU other than the higher-level ECU 10, multiple NM control masters may also be provided.

When providing multiple NM control masters 14a, 14b and/or multiple power supply control masters 16a, 16b, it is sufficient for the main NM control master 14a and/or the main power supply control master 16a to transmit the activation NM message and/or the relay control message, as long as the main NM control master 14a and/or the main power supply control master 16a are functioning normally. If any abnormality occurs in the main NM control master 14a and/or the main power supply control master 16a, the sub NM control master 14b and/or the sub power supply control master 16b may transmit the activation NM message and/or the relay control message in place of the main NM control master 14a and/or the main power supply control master 16a. In this case, the occurrence of an abnormality in the main NM control master 14a and/or the main power supply control master 16a may be detected by the sub NM control master 14b and/or the sub power supply control master 16b, or it may be detected by a dedicated abnormality detection circuit.

(Modification Example 2) In the above-described embodiment, a message authenticator for authenticating the validity of the message may be attached to the activation NM message and/or relay control message transmitted from the higher-level ECU 10 or the like to the first and second intermediate ECUs 20 and 30. As a result, it is possible to prevent the relay circuits 26, 28, and 36 from being turned on or off by activation NM messages and/or relay control messages that have been fraudulently transmitted through spoofing or the like.

The higher-level ECU 10 may calculate a hash value of the activation NM message and/or relay control message to be transmitted. Then, the higher-level ECU 10 may encrypt the hash value using a common key that has been previously shared with the first and second intermediate ECUs 20 and 30, and calculate a MAC (Message Authentication Code) value as a message authenticator. The higher-level ECU 10 may transmit the activation NM message and/or relay control message together with the MAC value to the first and second intermediate ECUs 20 and 30.

The first and second intermediate ECUs 20 and 30 may calculate the hash value of the received activation NM message and/or relay control message. Furthermore, the first and second intermediate ECUs 20 and 30 may decrypt the received MAC value using the common key to calculate the hash value. If the hash value they calculated matches the hash value obtained by decryption, the first and second intermediate ECUs 20 and 30 authenticate the validity of the received activation NM message and/or relay control message.

(Modification Example 3) The system and method described in the present disclosure may be implemented by a dedicated computer comprising a processor programmed to execute one or more functions embodied by a computer program. The system and method described in the present disclosure may be implemented using dedicated hardware logic circuits. The system and method described in the present disclosure may be implemented by one or more dedicated computers configured by a combination of a processor that executes a computer program and one or more hardware logic circuits. For example, some or all of the functions provided by the higher-level ECU 10, the first and second intermediate ECUs 20 and 30, and the first to third lower-level ECUs 40, 50, and 60 may be implemented as hardware. Modes for implementing a certain function as hardware include modes using one or more ICs or the like. Some or all of the functions provided by the higher-level ECU 10, the first and second intermediate ECUs 20 and 30, and the first to third lower-level ECUs 40, 50, and 60 may be implemented using any of a system-on-chip (SoC), an integrated circuit (IC), or a field-programmable gate array (FPGA). The concept of IC also includes ASICs (Application Specific Integrated Circuits). Further, the computer program may be stored, as instructions executed by a computer, on a computer-readable non-transitory tangible storage medium. As storage media for the program, an HDD (Hard Disk Drive), SSD (Solid State Drive), flash memory, or the like can be employed. Furthermore, a program for causing a computer to function as the higher-level ECU 10, the first and second intermediate ECUs 20 and 30, and the first to third lower-level ECUs 40, 50, and 60, as well as non-transitory tangible storage media such as semiconductor memory or the like on which such a program is recorded, are also encompassed within the scope of the present disclosure.

1. An in-vehicle network system comprising:
a first controller;
a second controller that is positioned hierarchically higher than the first controller, wherein the second controller includes at least one of (i) a first circuit and (ii) a first processor with a memory storing computer program code executable by the first processor, the at least one of the first circuit and the first processor configured to cause the second controller to turn on or off a relay circuit that is disposed on a power supply line to the first controller; and
a third controller including at least one of (i) a second circuit and (ii) a second processor with a memory storing computer program code executable by the second processor, wherein
the third controller includes a power supply control master and a NM control master,
the power supply control master is configured to transmit a relay control message to the second controller based on a vehicle state of a vehicle, the relay control message containing an instruction to turn on or off the relay circuit,
the NM control master is configured to transmit an activation network management (NM) message to the second controller through a communication bus in the vehicle in response to an activation trigger that requires the second controller to operate in a normal operation mode, the activation NM message causing the second controller in a low-power consumption mode to enter the normal operation mode and containing an instruction to selectively activate the first controller, and
the second controller is configured to turn on or off the relay circuit based on the instruction contained in the activation NM message until the second controller receives the relay control message from the power supply control master.

2. The in-vehicle network system according to claim 1, wherein
the power supply control master is configured to transmit the relay control message after the second controller has entered the normal operation mode in response to the activation NM message.

3. The in-vehicle network system according to claim 1, wherein
the second controller is configured to turn on or off the relay circuit based on the instruction contained in the relay control message instead of the instruction contained in the activation NM message when the second controller has received the relay control message from the power supply control master.

4. The in-vehicle network system according to claim 1, wherein
the second controller is configured to:
turn on or off the relay circuit based on the instruction contained in the activation NM message; and then
turn on or off the relay circuit based on the instruction contained in the relay control message when the second controller has received the relay control message.

5. The in-vehicle network system according to claim 1, wherein
the NM control master is configured to repeatedly transmit the activation NM message at predetermined intervals until the second controller receives the relay control message from the power supply control master.

6. The in-vehicle network system according to claim 5, wherein
the second controller is configured to:
activate in response to the activation NM message and enter the normal operation mode;
read an activation NM message that is received after activation of the second controller; and
turn on or off the relay circuit based on the instruction contained in the activation NM message received after the activation.

7. The in-vehicle network system according to claim 1, wherein
the second controller is configured to:
activate in response to the activation NM message and enter the normal operation mode; and then
turn on the relay circuit before reading the activation NM message or an activation NM message that is received after activation of the second controller.

8. The in-vehicle network system according to claim 7, wherein
the second controller is configured to turn off the relay circuit when the activation NM message having been read by the second controller contains an instruction to turn off the relay circuit.

9. The in-vehicle network system according to claim 1, wherein
the activation NM message and/or the relay control message includes a message authenticator to authenticate validity of the activation NM message and/or the relay control message.

10. The in-vehicle network system according to claim 1, wherein
the NM control master is one of multiple NM control masters, and
the second controller is configured to turn on the relay circuit when at least one of activation messages transmitted by the multiple NM control masters contains an instruction to turn on the relay circuit.

11. The in-vehicle network system according to claim 1, wherein
the second controller is configured to keep the relay circuit turned on for a predetermined period when the second controller turns on the relay circuit based on the activation NM message.

12. The in-vehicle network system according to claim 1, wherein
the third controller is positioned hierarchically higher than the second controller.

13. The in-vehicle network system according to claim 12, wherein
the second controller is one of second controllers, and
the power supply control master is configured to individually instruct the second controllers to turn on or off the relay circuit based on the vehicle state, using the relay control message.

14. A control method of an in-vehicle network system including a first controller and a second controller positioned hierarchically higher than the first controller, the control method comprising:
transmitting, to the second controller, a relay control message containing an instruction to turn on or off a relay circuit based on a vehicle state of a vehicle, the relay circuit being disposed on a power supply line to the first controller;
transmitting, to the second controller, an activation network management (NM) message through a communication bus in response to an activation trigger that requires the second controller to transition to a normal operation mode, the activation NM message causing the second controller to transition from a low-power consumption mode to the normal operation mode and containing an instruction to selectively activate the first controller; and
turning on or off, with a relay control unit of the second controller, the relay circuit based on the instruction contained in the activation NM message until the second controller receives the relay control message.

15. An in-vehicle network system comprising:
a first controller;
a second controller that is positioned hierarchically higher than the first controller, wherein the first controller and the second controller are connected to a communication bus to communicate with each other in a vehicle, and the second controller includes a relay control unit configured to turn on or off a relay circuit (26, 28, 36) that is disposed on a power supply line to the first controller;
a power supply control master configured to transmit a relay control message to the second controller based on a vehicle state of the vehicle, the relay control message containing an instruction to turn on or off the relay circuit; and
a NM control master configured to transmit an activation network management (NM) message to the second controller through the communication bus in response to an activation trigger that requires the second controller to transition to a normal operation mode, the activation NM message causing the second controller to transition from a low-power consumption mode to the normal operation mode and containing an instruction to selectively activate the first controller, wherein
the second controller is configured to turn on or off the relay circuit based on the instruction contained in the activation NM message until the second controller receives the relay control message from the power supply control master.

16. The in-vehicle network system according to claim 15, further comprising
a third controller that is positioned hierarchically higher than the second controller, wherein
the third controller includes the power supply control master.
